(19) United States
(12) Patent Application Publication
(10) Pub. No.: US 2016/0012679 A1
(43) Pub. Date: Jan. 14, 2016

(54) ENHANCING USER RETENTION AND ENGAGEMENT VIA TARGETED GAMIFICATION

(71) Applicant: Mobile Media Partners, Inc., Hasbrouck Heights, NJ (US)

(72) Inventor: Christopher Langbein, Wyckoff, NJ (US)

(21) Appl. No.: 14/328,301

(22) Filed: Jul. 10, 2014

(51) Int. Cl. G07F 17/32

(52) U.S. Cl. CPC G07F 17/3244

(57) ABSTRACT

A computing device is executing an application. The computing device is also in data communication with an external gamification platform, has one or more processors, and has a memory. The memory bears instructions that, when executed, cause the one or more processors to: request a gamified offer from the external gamified offer platform; present the gamified offer to the user; and reward the user based on an outcome of the gamified offer.

### TECHNICAL FIELD

This document relates to enhancing user retention and engagement via targeted gamification.

### BACKGROUND

User retention and engagement are among the challenges faced by application developers. “User retention” refers to the degree to which users keep the application installed on a device, while “user engagement” refers to the degree to which a user actually uses the application. Most application developers strive to achieve high user retention and engagement.

### SUMMARY

In general, in one aspect, a computing device is executing an application. The computing device is also in data communication with an external gamification platform, has one or more processors, and has a memory. The memory bears instructions that, when executed, cause the one or more processors to: request a gamified offer from the external gamified offer platform; present the gamified offer to the user; and reward the user based on an outcome of the gamified offer.

Implementations may have one or more of the following features. Identifying an application state at which the user is expected to disengage the application, and presenting the gamified offer to the user at the identified application state. The application state is identified based at least in part on activity logs collected from the application. Requesting a gamified offer is accomplished via a software development kit provided by the gamified offer platform. Requesting the gamified offer is accomplished via a single line of source code. Audio, graphical, or video content is combined with the gamified offer prior to presenting the gamified offer, thereby customizing the gamified offer to match an aesthetic aspect of the application. Rewarding the user includes providing the user with a token, and transmitting a description of the token to the gamified offer platform, thereby allowing a token inventory of the user to be synchronized across a plurality of devices.

Other aspects include other combinations of the features recited above and other features, expressed as methods, apparatus, systems, program products, and in other ways. Other features and advantages will be apparent from the description and from the claims.

### DESCRIPTION OF DRAWINGS

FIG. 1 is a schematic depiction of a gamification platform.

FIG. 2 is a block diagram a gamification platform and its components.

FIG. 3 is a flowchart for serving gamified offers.

FIG. 4 is a schematic depiction of an exemplary gamified offer.

Like references numbers refer to like structures.

### DETAILED DESCRIPTION

One reason for a user to disengage from using an application is that the user grows bored with the application; or alternatively, the user considers using a different application to be more entertaining or productive. The techniques described below mitigate disengagement by, in part, allowing application developers to insert engaging and rewarding content at points in applications where users are expected to disengage. In particular, the techniques described below can be used, among other things, to serve “gamified offers” to users.

A “gamified offer” includes two components: an interactive portion and a benefit. The interactive portion calls for a user to interact with the gamified offer in a specified manner. For example, an interactive portion can include a game or game-like scenario, such as completing a lottery-type scratch ticket; completing a short puzzle; completing a trivia quiz; etc. Other interactions are possible.

The benefit of a gamified offer is anything of value that the user receives by virtue of suitably interacting with the gamified offer. For example, benefits may include free merchandise or discounts at a physical or online store or a group of stores, free or discounted access to services from a service provider, virtual goods or currency in the context of one or more applications or online environments, entrance into a lottery where the user can win any of the foregoing, electronic tokens or game-pieces that can be redeemed in certain combinations for any of the foregoing, etc. Other benefits are possible.

Some existing applications feature similar functionality. One category of games involves presenting the user with an opportunity to earn in-game virtual currency when the user first starts the game. For example, in an online poker application, the user may be presented with functionality (e.g., in the form of a slot machine or wheel-of-fortune) in which the user can win one of several amounts of poker chips. Another category of games features such functionality during gameplay. For example, in an online poker application, a user who has folded his poker hand may opt to engage similar slot machine or wheel-of-fortune functionality while waiting for a new hand to start.

Traditionally, this functionality is developed from scratch and is integrated into the application itself. This approach involves a relatively high amount of effort on the part of the application's developers. Moreover, such integrated functionality is somewhat inflexible, in the sense that moving or changing the functionality may require significant changes to the underlying application.

The techniques below advantageously allow application developers to include gamified offers at desired parts of an application. Moreover, such inclusion can be accomplished with relatively little effort, and with relatively high flexibility.

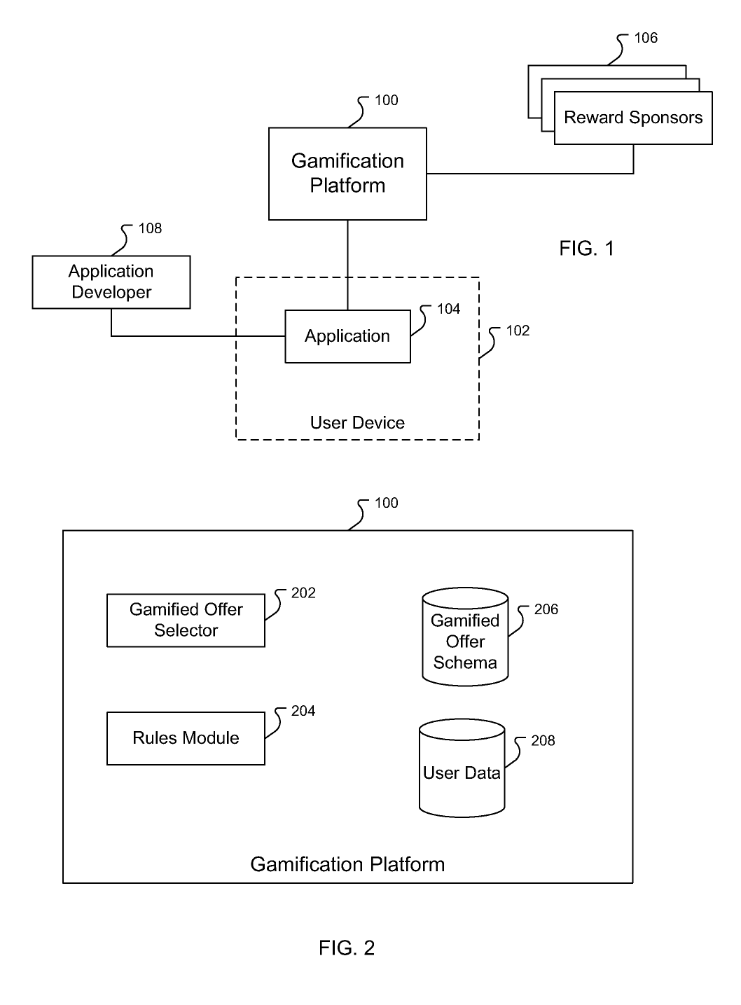

FIG. 1 is a schematic depiction of a gamification platform. The platform 100 is in data communication with a user device 102 executing an application 104. The user device 102 may include (but need not be limited to) any computing device, such as a desktop computer, laptop computer, mobile device (including a tablet, a smartphone, a smartwatch, etc.). The application 104 may be any application suitable for the hardware of device 102, including (but not limited to) games, media viewers, social or location-based applications, productivity applications, etc. In some implementations, the application 104 may include the operating system of the device 102.

The gamification platform 100 is also in data communication with one or more reward sponsors 106. The reward sponsors 106 provide the benefits associated with the gamified offers served in the application 104. Although the application developer 108 is shown as distinct from the reward sponsor 106, the reward sponsors may include the developer of the application 104 (e.g., when the benefit associated with the gamified offer includes virtual goods or currency to be used in the application 104). The reward sponsors 106 may include other entities motivated to provide offers, e.g. as part of the sponsor's marketing efforts.

FIG. 2 is a block diagram of a gamification platform's components. The gamification platform 100 includes a gamified offer selector 202, a rules module 204, a data store bearing gamified offer schema 206, and a data store bearing status data 208. The components 202-208 may be implemented in any known fashion, including as software, hardware, or a combination of software and hardware. Although the data stores 206 and 208 are depicted separately, in principle their contents may reside on a single physical or logical data store, or distributed across several physical or logical data stores.

The gamified offer selector 202 is operable to select a gamified offer to be served to a particular user at a particular time. For example, if the interaction portions of available gamified offers include scratch-ticket type lotteries, short puzzles, trivia quizzes, etc., then the gamified offer selector 202 may select amongst these interactive portions based on any criterion or a combination of criteria. Similarly, if the benefits of available gamified offers include discounted or free merchandise from various sponsors, virtual goods or currency from the application developer, etc., then the gamified offer selector 202 may also select amongst these benefits based on any criterion or combination of criteria. Such criteria may include (but need not be limited to): user preferences, application developer preferences (as communicated through the application), reward sponsor preferences, maximizing the probability of a particular outcome (e.g., winning a grand prize), maximizing the expected value of a completed offer, maximizing the expected revenue to the operator of the gamification platform, etc.

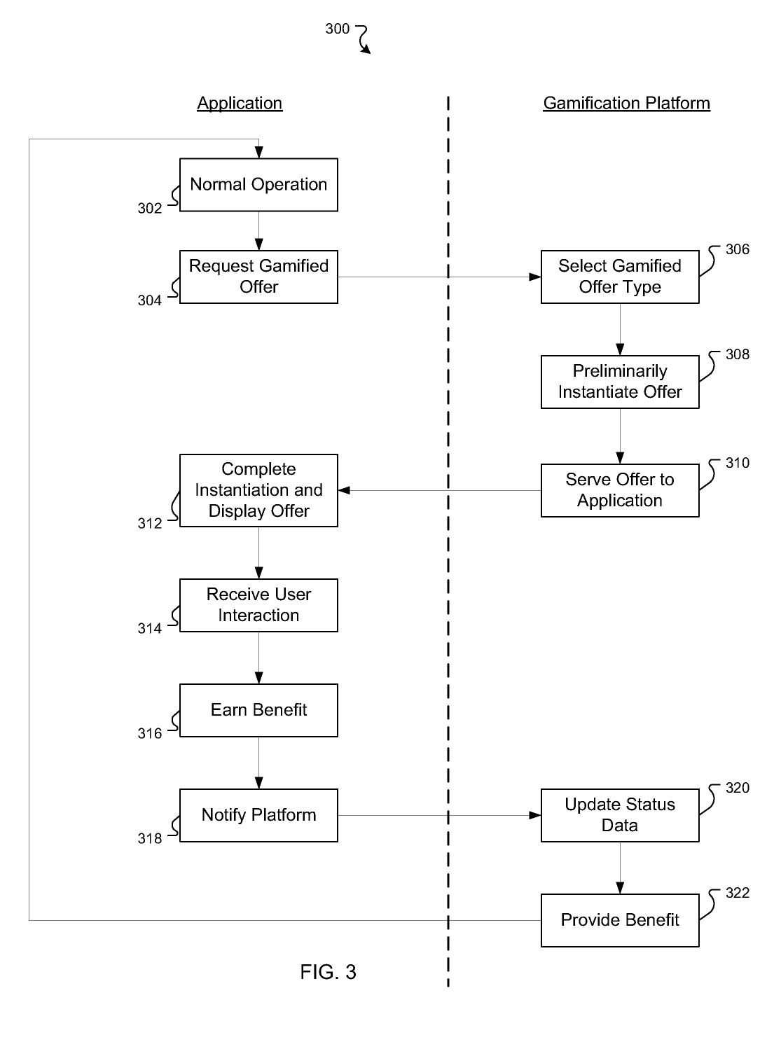

The rules module 204 is operable to instantiate a gamified offer selected by the gamified offer selector 202. As explained more fully below (see FIG. 3, 308), “instantiation” involves supplying particular values or making particular decisions, subject to applicable constraints, in order to create a playable gamified offer. By contrast, the gamified offer schema 206 includes abstract rules or instructions for serving particular type of gamified offers.

For example, one example of a gamified offer involves presenting the user with a digital “scratch ticket,” in which the user selects one or more boxes from a greater number of available boxes. Each box corresponds to a particular symbol or value, which is revealed when the user selects the particular box. Certain combinations of symbols or values correspond with certain rewards. In this example, the gamified offer scheme sets forth the parameters of the gamified offer—i.e., how many boxes are presented to the user; what possible symbols may correspond to each box; how many boxes the user may select; what combinations of symbols correspond to which benefits; any graphic, audio, video, or other content associated with presenting the offer, etc.

The status data 208 includes any and all data pertinent to the instantiation of offers. For example, it may be desirable to impose certain constraints on a population of instantiated offers. In a simple example, a particular gamified offer may require that there is only one grand prize. When the grand prize is won, this is recorded in the status data 208, so that future instances of that gamified offer will not allow for the grand prize to be won again. More generally, constraints on populations of instantiated offers may include a minimum or maximum number of benefits of a certain type being earned across all users; a minimum or maximum number of benefits of a certain type being earned by a particular user or group of users; a requirement that certain users necessarily earn or necessarily do not earn certain benefits; etc. These constraints may be implemented by recording pertinent data in the status data 208, including (but not limited to) the actual distribution of earned benefits for gamified offers at a given time, as well as constraints on the available benefits in the future. Other pertinent status data is possible.

In some implementations, the status data 208 can also include historical data describing which users have earned which benefits in the variously available gamified offers. This can be particularly advantageous for gamified offers in which users earn one of several possible tokens for each instance of a gamified offer. In this case, the user's inventory of tokens is recorded on the gamified offer platform, which allows relatively easy synchronization of the user's inventory across several devices that belong to the user.

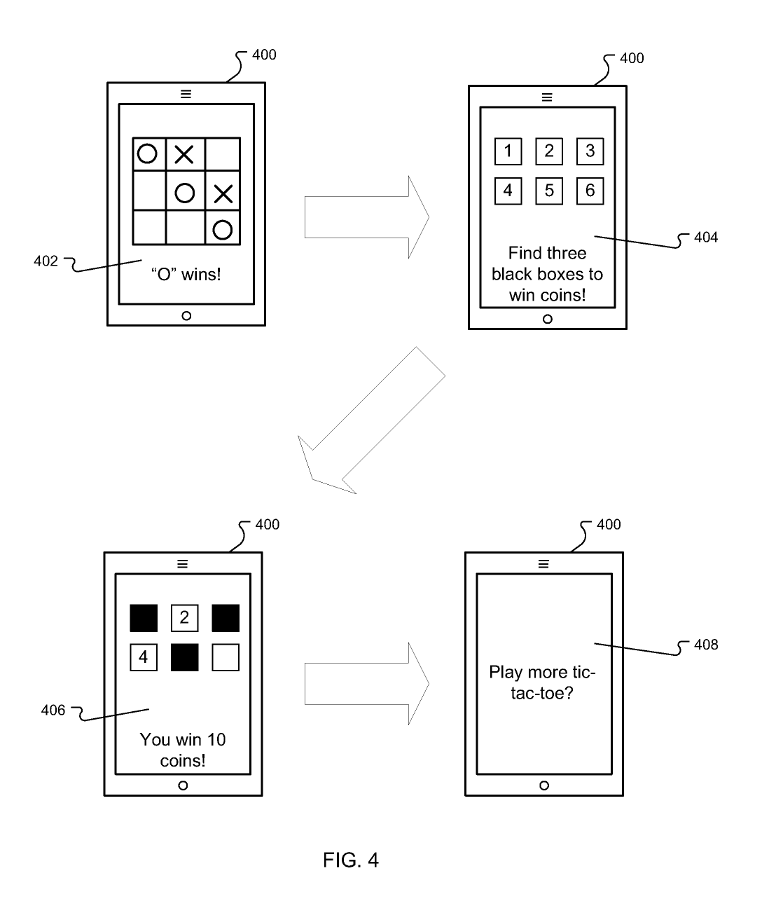

FIG. 3 is a flowchart for serving gamified offers. FIG. 3 can be further understood with respect to FIG. 4, which is a schematic depiction of an exemplary gamified offer being served. Although FIG. 3 depicts a certain division of labor between an application and the gamification platform, it should be noted that this division of labor is exemplary and that other divisions of labor are possible. Indeed, the tasks described in FIG. 3 may be distributed in a variety of ways over a number of systems, not just limited to the application and the gamification platform.

Referring to FIG. 3, method 300 begins with the normal operation of an application executing on a user's computing device (step 302). At some point, the application enters a state that causes the application to request a gamified offer from the gamification platform. In the example of FIG. 4, the application is a tic-tac-toe game executing on a mobile device 400. When the user finishes a game, the application enters state 402, which for the purposes of this example causes the application to request a gamified offer.

In some implementations, the timing with which gamified offers are requested can be advantageously determined. For example, presenting offers at a point or application state in which a user is expected to disengage the application can enhance user engagement and retention. Identifying a point or application state in which a user is expected to disengage can be accomplished by any means. In some implementations activity logs can be used to help determine, at least in part, points or states at which users commonly disengage the application. In a separate example, gamified offers can be served to users to promote initial engagement (rather than prevent disengagement). For example, offers can be served directly a lock screen of a mobile operating system on the occurrence of a pre-defined condition, such as a passage of time since last engagement, when the device or the operating system is in a pre-defined state, or other conditions.

In some implementations, the operators of the gamification platform maintain a software development kit (“SDK”) that enables application developers to incorporate gamified offers with relatively little effort. In some implementations, the SDK can be used to invoke a gamified offer with only a single line of source code. Thus, advantageously, application developers can easily re-locate gamified offers within an application. In particular, application developers can easily request gamified offers to be served to users at states at which users are expected to disengage the application. More generally, application developers can advantageously include gamified offers (whether served from a gamification platform or otherwise) at states at which users are expected to disengage the application.

Referring back to FIG. 3, the gamification platform 100 determines which gamified offer type to serve (step 306), including determining a game type (e.g., puzzle, scratch ticket, etc.) and the associated benefit of the gamified offer. This selection can be made with respect to the various criteria discussed above, among others. Once the gamified offer type is selected, then a gamified offer is preliminarily instantiated based on a corresponding gamified offer scheme (step 308).

Preliminary instantiation involves supplying particular values or making particular decisions, subject to applicable constraints of the gamified offer scheme, in order to create a playable gamified offer. Such decisions include but are not limited to the ultimate outcome of the gamified offer (or the possible outcomes depending on user interaction). In some implementations, the gamified offer scheme may call for constraints on possible offer outcomes (for example, a certain proportion of offers will or can possibly provide a certain benefit). In some implementations, this constraint is a probabilistic constraint (for example, a certain benefit results from a certain gamified offer with a certain probability). In some implementations, this constraint involves a maximum of minimum number of particular outcomes (for example, winners of a certain benefit, etc.). Other constraints are possible.

With the gamified offer preliminarily instantiated, the offer is served to the application (310), and the application then completes the instantiation of the gamified offer (step 312). The completion of the instantiation includes supplying any cosmetic information—e.g., audio, graphics, video, etc.—that an application developer may want to include in order to harmonize the aesthetics of the gamified offer with the aesthetics of the underlying application. Although this step is depicted as being performed within the application in FIG. 3, in principal this step can be performed on either the user device, the gamification platform, or at another location by another process. In some implementations, an application developer uploads audio, graphical, video, or other resources to the gamification platform so that instantiation of the gamified offer can be completed entirely on the gamification platform. In some implementations, these audio, graphical, video, or other resources are stored locally on users' devices. In some implementations, these audio, graphical, video, or other resources are stored on and retrieved from a server under the control of the application developer during step 312.

With the gamified offer now completely instantiated, it is displayed to the user. In the context of the example of FIG. 4, displaying the gamified offer puts the device 400 into state 404, in which a “scratch ticket” is displayed and the user is prompted to select numbered boxes. Selecting a box reveals whether the box is a winning black box, or a non-winning white box.

Referring back to FIG. 3, user interaction with the gamified offer is received (step 314) and a resulting benefit is earned (step 316). For example, the interaction may constitute making selections, providing control instructions for a character, providing input for a trivia question, etc. In some implementations, no significant input is required. The gamified offer provides output accordingly, until the outcome of the offer is achieved. For example, in FIG. 4 after the user has made a number of selections, the gamified offer is in state 406, and the outcome of the offer is that the user receives ten coins as a benefit.

In step 318, the application notifies the gamification platform about the outcome of the gamified offer, as well as any other data that is pertinent to the platform operation. The gamification platform updates status data accordingly (step 320), which may affect how future gamified offers are instantiated. Finally, in step 322, the benefit is provided to the user. In some implementations (e.g., when the benefit includes virtual currency or is otherwise pertinent to the application), providing the benefit includes sending a message or signal back to the application to make the benefit available. In some implementations, providing the benefit includes sending a message or signal to a third party, such as an offer sponsor, to make the benefit available to the user (e.g., by sending the user an email with a coupon code, sending the user a package via the US mail or private courier, etc.) In some implementations, the benefit is provided entirely within the gamification platform itself. For example, this may be the case when the benefit of a gamified offer includes one of several possible tokens, in which certain collections of tokens entitle the user to further benefits. In this example, gamification platform may track the user's token inventory within the platform itself. Advantageously, this scenario makes it relatively easy to track a user's inventory across several user devices.

The above systems, devices, methods, processes, and the like may be realized in hardware, software, or any combination of these suitable for the control, data acquisition, and data processing described herein. This includes realization in one or more microprocessors, microcontrollers, embedded microcontrollers, programmable digital signal processors or other programmable devices or processing circuitry, along with internal and/or external memory. This may also, or instead, include one or more application specific integrated circuits, programmable gate arrays, programmable array logic components, or any other device or devices that may be configured to process electronic signals. It will further be appreciated that a realization of the processes or devices described above may include computer-executable code created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software. At the same time, processing may be distributed across devices such as the various systems described above, or all of the functionality may be integrated into a dedicated, standalone device. All such permutations and combinations are intended to fall within the scope of the present disclosure.

In some embodiments disclosed herein are computer program products comprising computer-executable code or computer-usable code that, when executing on one or more computing devices (such as the devices/systems described above), performs any and/or all of the steps described above. The code may be stored in a non-transitory fashion in a computer memory, which may be a memory from which the program executes (such as random access memory associated with a processor), or a storage device such as a disk drive, flash memory or any other optical, electromagnetic, magnetic, infrared or other device or combination of devices. In another aspect, any of the processes described above may be embodied in any suitable transmission or propagation medium carrying the computer-executable code described above and/or any inputs or outputs from same.

It will be appreciated that the methods and systems described above are set forth by way of example and not of limitation. Numerous variations, additions, omissions, and other modifications will be apparent to one of ordinary skill in the art. In addition, the order or presentation of method steps in the description and drawings above is not intended to require this order of performing the recited steps unless a particular order is expressly required or otherwise clear from the context.

The meanings of method steps of the invention(s) described herein are intended to include any suitable method of causing one or more other parties or entities to perform the steps, consistent with the patentability of the following claims, unless a different meaning is expressly provided. Such parties or entities need not be under the direction or control of any other party or entity, and need not be located within a particular jurisdiction.

Thus for example, a description or claim limitation of “adding a first number to a second number” is intended to be construed as including (1) adding the numbers together, and (2) causing one or more parties or entities to add the two numbers together. For example, if person X engages in an arm's length transaction with person Y to add the two numbers, and person Y indeed adds the two numbers, then both persons X and Y perform the step as recited: person Y by virtue of the fact that he actually added the numbers, and person X by virtue of the fact that he caused person Y to add the numbers. Furthermore, if person X is located within the United States and person Y is located outside the United States, then the method is performed in the United States by virtue of person X's participation in causing the step to be performed. This is similarly true if “person Y” in the previous example is replaced by a computer outside of person X's direction or control, that nonetheless adds the two numbers at person X's request.

While the invention has been disclosed in connection with certain embodiments, other embodiments are possible and will be recognized by those of ordinary skill in the art. All such variations, modifications, and substitutions are intended to fall within the scope of this disclosure. Thus, the invention is to be understood with reference to the following claims.

What is claimed is:

1. A system comprising:
a computing device executing an application, the computing device:
being in data communication with an external gamification platform;
having one or more processors;
having a memory bearing instructions that, when executed, cause the one or more processors to:
request a gamified offer from the external gamified offer platform;
present the gamified offer to the user; and
reward the user based on an outcome of the gamified offer.

2. The system of claim 1, wherein the gamified offer is presented to the user at an application state at which the user is expected to disengage the application.

3. The system of claim 2, wherein the application state is identified based at least in part on activity logs collected from the application.

4. The system of claim 1, in which requesting a gamified offer is accomplished via a software development kit provided by the gamified offer platform.

5. The system of claim 1, in which requesting the gamified offer is accomplished via a single line of source code.

6. The system of claim 1, the memory further comprising audio, graphical, or video content to be combined with the gamified offer prior to presenting the gamified offer, thereby customizing the gamified offer to match an aesthetic aspect of the application.

7. The system of claim 1, in which rewarding the user includes providing the user with a token, the instructions further comprising instructions to transmit a description of the token to the gamified offer platform, thereby allowing a token inventory of the user to be synchronized across a plurality of devices.

8. A method comprising:
in an application executing on a computing device, causing the computing device to request a gamified offer from an external gamified offer platform;
presenting the gamified offer to the user; and
rewarding the user based on an outcome of the gamified offer.

9. The method of claim 8, further comprising identifying an application state at which the user is expected to disengage the application, wherein the gamified offer is presented to the user at the identified application state.

10. The method of claim 9, further comprising identifying the application state at which the user is expected to disengage based at least in part on activity logs collected from the application.

11. The method of claim 8, in which requesting a gamified offer is accomplished via a software development kit provided by the gamified offer platform.

12. The method of claim 8, in which requesting the gamified offer is accomplished via a single line of source code.

13. The method of claim 8, further comprising providing audio, graphical, or video content to be combined with the gamified offer prior to presenting the gamified offer, thereby customizing the gamified offer to match an aesthetic aspect of the application.

14. The method of claim 8, in which rewarding the user includes providing the user with a token, further comprising transmitting a description of the token to the gamified offer platform, thereby allowing a token inventory of the user to be synchronized across a plurality of devices.
